(19) United States
(12) Patent Application Publication
(10) Pub. No.: US 2013/0182811 A1
(43) Pub. Date: Jul. 18, 2013

(54) Method of Monitoring Reactor Bottom Area, Reactor Bottom Area Monitoring Apparatus and Nuclear Reactor

(71) Applicant: HITACHI-GE NUCLEAR ENERGY, LTD., Hitachi-shi (JP)

(72) Inventors: Atsushi BABA, Tokai-mura (JP); Atsushi FUSHIMI, Hitachi-shi, Ibaraki (JP); Izumi YAMADA, Tokai-mura (JP); Yoshinori MUSHA, Hitachiota-shi, Ibaraki (JP); Setsuo ARITA, Hitachiota-shi, Ibaraki (JP); Akira MURATA, Hitachi-shi, Ibaraki (JP); Tamotsu ASANO, Hitachi-shi, Ibaraki (JP); Mikio KOYAMA, Hitachi-shi, Ibaraki (JP); Hiroaki KATSUYAMA, Hitachi-shi, Ibaraki (JP); Ryuta HAMA, Hitachi-shi, Ibaraki (JP)

(73) Assignee: HITACHI-GE NUCLEAR ENERGY, LTD., Hitachi-shi (JP)

(21) Appl. No.: 13/730,767

(22) Filed: Dec. 28, 2012

(30) Foreign Application Priority Data
Jan. 6, 2012 (JP) 2012-001069

(51) Int. Cl. G21C 17/035

(52) U.S. Cl. CPC G21C 17/035
USPC 376/259

(57) ABSTRACT

An ultrasonic sensor has a piezo-electric element attached at an end surface outside a reactor pressure vessel (RPV) of a sensor leading edge portion. The sensor leading edge portion passes through a bottom head of the RPV and is installed on the bottom head. Ultrasonic waves generated by the piezo-electric element are propagated to the sensor leading edge portion and are propagated to reactor water in the RPV from the sensor leading edge portion. When water surface of the reactor water in the RPV exists below a core support plate, the ultrasonic waves propagated inside the reactor water are reflected on the water surface. Ultrasonic waves reflected on the water surface are propagated into the reactor water, enter the sensor leading edge portion, and are received by the piezo-electric element. Using the ultrasonic waves received by the piezo-electric element, the water level in the RPV is obtained.

### CLAIM OF PRIORITY

The present application claims priority from Japanese Patent application serial no. 2012-001069, filed on Jan. 6, 2012, the content of which is hereby incorporated by reference into this application.

### BACKGROUND OF THE INVENTION

1. Technical Field

The present invention relates to a method of monitoring reactor bottom area, a reactor bottom area monitoring apparatus and a nuclear reactor and more particularly to a method of monitoring reactor bottom area, a reactor bottom area monitoring apparatus and a nuclear reactor which are preferably applicable to a boiling water reactor.

2. Background Art

The boiling water reactor disposes a core loading a plurality of fuel assemblies in a reactor pressure vessel (hereinafter, referred to as RPV) and disposes a steam separator and a steam drier above the core in an RPV. A bottom head are formed on a bottom of the RPV and an upper head is removably attached to an upper end of the RPV. A core shroud disposed in the RPV and surrounding the core is supported on an inner surface of the RPV by a core shroud support structure. A lower end portion of the fuel assembly loaded on the core is supported by a core support plate attached to the core shroud.

Cooling water in the RPV is pressurized by a pump and supplied into the fuel assemblies loaded in the core from a lower plenum formed below the core in the RPV. The cooling water is heated by heat generated by nuclear fission of a nuclear fuel material included in the fuel assembly, and a part thereof becomes steam. A gas-liquid two-phase flow including the steam and cooling water is introduced into the steam separator, and the steam is separated from cooling water in the steam separator. Moisture included in the separated steam is removed by the steam drier. The steam discharged from the steam drier is discharged from the RPV into a main steam pipe and is supplied to a steam turbine.

Conventionally, the water level in the RPV is measured by a differential pressure type water level gauge installed in the RPV. This water level gauge includes a condenser connected to an upper instrumentation pipe pulled out outside the RPV from the neighborhood of the steam drier, another instrumentation pipe connected to the condenser, a lower instrumentation pipe pulled out outside the RPV from the neighborhood of the core support plate, and a differential pressure gauge disposed outside the RPV. The above another instrumentation pipe and the lower instrumentation pipe are connected to the differential pressure gauge. A standard water level is formed in the condenser and the differential pressure gauge measures the pressure difference between the condenser and the lower instrumentation pipe. The pressure difference is converted to the water level in the RPV.

Further, the above-mentioned differential pressure gauge is installed outside a reactor containment vessel surrounding the RPV. In the differential pressure type water level gauge, the steam introduced through the upper instrumentation pipe is condensed to water in the condenser, forms the standard water level, and holds a constant steam pressure. By dong this, the pressure of the sum of the water in the instrumentation pipe connected to the condenser and the standard water level in the condenser is added to the differential pressure gauge. On the other hand, the lower instrumentation pipe adds the water pressure corresponding to the water level in the RPV in the neighborhood of the core support plate to the differential pressure gauge. The differential pressure type reactor water level gauge converts the change in the pressure difference associated with the water level change in the RPV to a water level and measures the water level.

Further, a method for measuring the water level in a RPV using ultrasonic waves without using a differential pressure gauge is described in, for example, Japanese Patent Laid-Open No. 5(1993)-273033, Japanese Patent Laid-Open No. 11(1999)-218436, and Japanese Patent Laid-Open No. 6(1994)-281492.

For example, Japanese Patent Laid-Open No. 5(1993)-273033 describes a reactor water level measuring apparatus capable of measuring the reactor water level of a reactor accurately by one measuring system using ultrasonic waves without requiring an instrumentation pipe. In Japanese Patent Laid-Open No. 5(1993)-273033, an ultrasonic waveguide including a side hole is installed vertically, and an ultrasonic transducer is installed on an outer surface of a bottom of the RPV so that each central axial line of the ultrasonic transducer and ultrasonic waveguide coincides with each other, and the ultrasonic signal obtained by transmitting and receiving ultrasonic waves is processed, and the reactor water level is displayed.

Further, Japanese Patent Laid-Open No. 11(1999)-218436 describes an ultrasonic liquid level measuring apparatus which can accurately perform the measurement of the liquid level in the liquid phase in noncontact with the measured object and moreover, has improved environmental resistance. In Japanese Patent Laid-Open No. 11(1999)-218436, ultrasonic waves are transmitted from a ultrasonic transmission means connected to any one of a plurality of ultrasonic probes installed on an outside wall surface of a liquid tank inward the liquid tank, and the reflected pulse of the ultrasonic pulse transmitted by the ultrasonic transmission means from an inner wall surface of the liquid tank is received by ultrasonic reception means connected to the remaining ultrasonic probes. The signal detection means calculates the signal level and propagation time of the reflected pulse received by the ultrasonic reception means for each ultrasonic reception means, and the liquid level conversion means converts the liquid level in the liquid tank based on the attenuation factor of the reflected pulse and the attaching positions of the ultrasonic probe on the reception side and the ultrasonic probe on the transmission side, and outputs the converted liquid level to the liquid level output means.

Furthermore, Japanese Patent Laid-Open No. 6(1994)-281492 describes a method of measuring a water level in a pipe such as a steam generator pipe, the method being for monitoring accurately and continuously the water level in the steam generator pipe of the PWR at the time of periodic inspection. In Japanese Patent Laid-Open No. 6(1994)-281492, an ultrasonic sensor is disposed on a lower surface of the pipe horizontally installed, and the ultrasonic waves emitted upward are reflected on the water surface in the pipe and are received, and the time difference between reception and transmission is measured and detected, thus the water level in the pipe is measured.

### CITATION LIST

### Patent Literature

[Patent Literature 1] Japanese Patent Laid-Open No. 5(1993)-273033

[Patent Literature 2] Japanese Patent Laid-Open No. 11(1999)-218436

[Patent Literature 3] Japanese Patent Laid-Open No. 6(1994)-281492

### Non Patent Literature

[Non Patent Literature 1] IIC REVIEW/2009/10, No. 42, pp. 39

[Non Patent Literature 2] 1999 Japan Society of Mechanical, Steam Table, BASED ON IAPWS-IF97, pp. 128-129

### SUMMARY OF THE INVENTION

### Technical Problem

In a conventional differential pressure type water level gauge, the upper instrumentation pipe, the lower instrumentation pipe, furthermore, the condenser, and the instrumentation pipes for connecting these components are used to measure the water level in the RPV. Further, in this differential pressure gauge, for example, three types of differential pressure gauges such as for low pressure, for medium pressure, and for high pressure are necessary depending on the measurable pressure range, and in correspondence to it, the instrumentation pipe structure becomes complicated, and the quantity increases. Furthermore, when measuring the water level in a region below the core support plate, that is, a reactor bottom area in the RPV, the instrumentation pipe is pulled out from the RPV bottom where many structural members such as control rods, control rod drive mechanisms, and incore instrumentation pipes are arranged, and must be additionally installed. Therefore, a problem arises that the structure of the reactor itself becomes complicated.

Further, in the techniques described in Japanese Patent Laid-Open No. 5(1993)-273033, Japanese Patent Laid-Open No. 11(1999)-218436, and Japanese Patent Laid-Open No. 6(1994)-281492, the ultrasonic sensor must be attached to a bottom or a side outside of the RPV. In this case, on the inner surface of the RPV, a vessel lining called a cladding layer of stainless steel or nickel-base alloy is formed by welding and moreover, many welded structures such as the control rod drive mechanism stub tube and the incore instrumentation pipe housing exist on the bottom of the RPV. Therefore, the ultrasonic waves must have sufficient sensitivity characteristics to permit ultrasonic waves to be propagated and measure the water level inside the RPV. However, the ultrasonic sensor operating in a high-temperature environment at about 300° C. in the reactor operation state is said to be generally low in sensitivity. Further, the surface shapes of the welded structures on the RPV bottom are a curved shape and moreover, are in an as-built shape due to a on site construction, so that while the temperature is changed up to about 300° C., the control of the refraction of ultrasonic waves on the boundary surface between the inner curved surface of the RPV and the reactor water is difficult and the transmission and reception of ultrasonic waves in the intended direction is difficult. Therefore, the direct measurement of the water level on the RPV bottom by ultrasonic waves is difficult.

An object of the present invention is to provide a method of monitoring reactor bottom area, a reactor bottom area monitoring apparatus and a nuclear reactor which can avoid a complication of a reactor structure and improve the SN ratio.

### Solution to Problem

A feature of the present invention for attaining the above object comprises steps of propagating ultrasonic waves generated by a ultrasonic vibration element of a ultrasonic sensor to a sensor leading edge portion of the ultrasonic sensor which penetrates a bottom portion of a reactor pressure vessel; propagating the ultrasonic waves propagated to the sensor leading edge portion to reactor water in the reactor pressure vessel; receiving reflected waves of the ultrasonic waves propagated to the reactor water by the ultrasonic sensor; and monitoring a state of a reactor bottom area in the reactor pressure vessel by using the received reflected waves.

The ultrasonic waves generated by the ultrasonic vibration element of the ultrasonic wave sensor are propagated to the sensor leading edge portion of the ultrasonic sensor which penetrates the bottom portion of the reactor pressure vessel by passing through it, and the ultrasonic waves propagated to the sensor leading edge portion are propagated to the reactor water in the reactor pressure vessel, so that a complication of the reactor structure can be avoided and the SN ratio in monitoring of the reactor bottom area can be improved.

### Advantageous Effect of the Invention

According to the present invention, a complication of the reactor structure can be avoided and the SN ratio in monitoring of the reactor bottom area can be improved.

### BRIEF DESCRIPTION OF THE DRAWINGS

FIG. 1 is an explanatory drawing showing a method of monitoring reactor bottom area according to embodiment 1, which is a preferable embodiment of the present invention, applied to a boiling water reactor.

FIG. 2 is a longitudinal sectional view sowing a boiling water reactor to which a method of monitoring reactor bottom area shown in FIG. 1 is applied.

FIG. 3 is an explanatory drawing showing the a propagation path of ultrasonic waves transmitted from an ultrasonic sensor installed on a bottom head of a reactor pressure vessel shown in FIG. 1 in a state that a region below a core support plate in the reactor pressure vessel is filled with cooling water.

FIG. 4 is an explanatory drawing showing a propagation path of ultrasonic waves transmitted from an ultrasonic sensor installed on a bottom head of a reactor pressure vessel shown in FIG. 1 in a state that liquid surface of cooling water exists below a core support plate in the reactor pressure vessel.

FIG. 5 is an explanatory drawing showing received waveform of ultrasonic waves at the time of water level measurement in embodiment 1 in each state shown FIGS. 3 and 4.

FIG. 6 is a flow chart showing flow of water level measurement in a reactor pressure vessel in embodiment 1.

FIG. 7 is an explanatory drawing showing measurement of fallen parts fallen in the reactor bottom area of a reactor pressure vessel in Example 1.

FIG. 8 is an explanatory drawing showing received waveform of ultrasonic waves at the time of fallen parts measurement shown in FIG. 7 in each case in which no fallen parts exists and in which fallen parts exists.

FIG. 9 is an explanatory drawing showing a method of monitoring reactor bottom area according to embodiment 2, which is another preferable embodiment of the present invention, applied to the boiling water reactor.

FIG. 10 is an explanatory drawing showing received waveform of ultrasonic waves at the time of water level measurement in embodiment 2 in each state shown FIGS. 4 and 9.

FIG. 11 is an explanatory drawing showing a method of monitoring reactor bottom area according to embodiment 3, which is another preferable embodiment of the present invention, applied to the boiling water reactor.

FIG. 12 is an explanatory drawing showing a method of monitoring reactor bottom area according to embodiment 4, which is another preferable embodiment of the present invention, applied to the boiling water reactor.

### DETAILED DESCRIPTION OF THE PREFERRED EMBODIMENTS

The embodiments of the present invention will be explained below.

### Embodiment 1

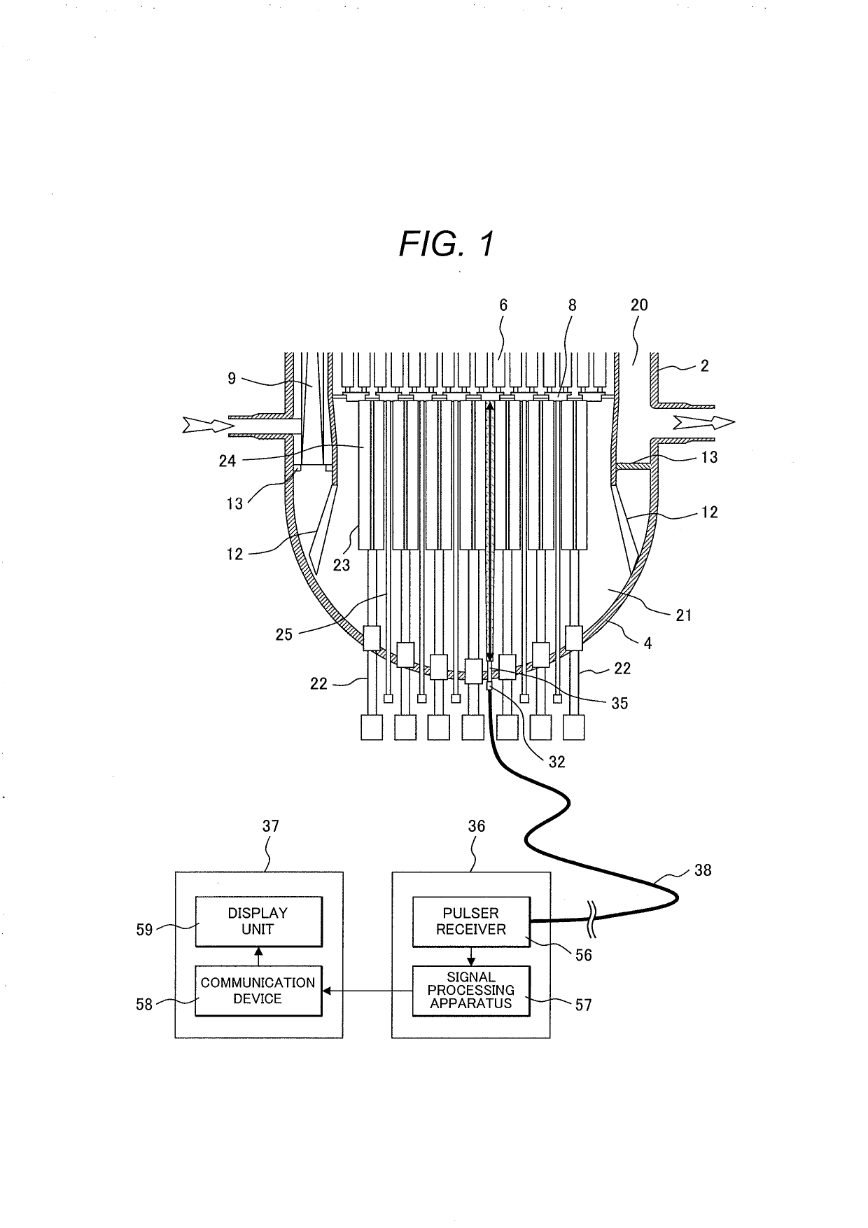

A method of monitoring reactor bottom area according to embodiment 1, which is a preferable embodiment of the present invention, applied to a boiling water reactor will be explained by referring to FIGS. 1 to 4.

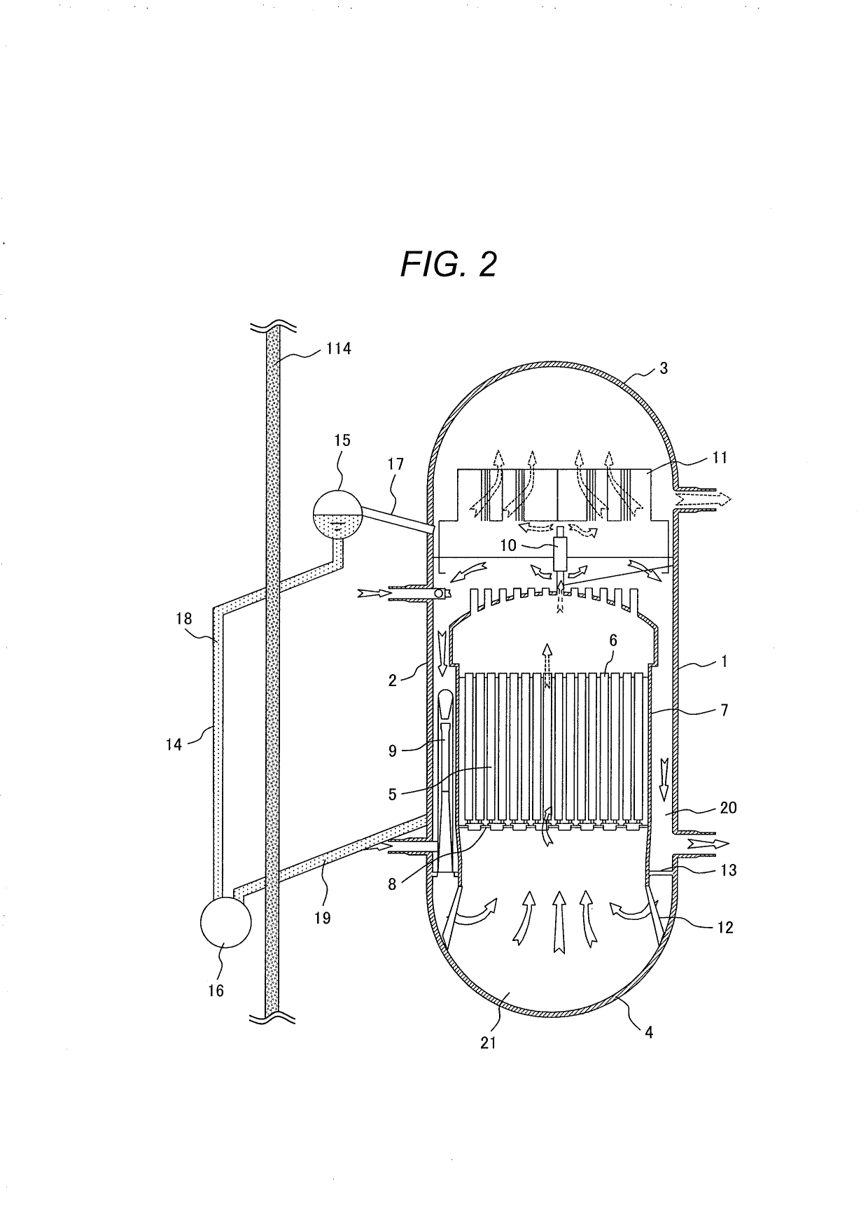

Firstly, a schematic structure of the boiling water reactor to which the method of monitoring reactor bottom area of the present embodiment is applied will be explained by referring to FIG. 2. A boiling water reactor 1 is surrounded by a reactor containment vessel 114. The boiling water reactor 1 is provided with a reactor pressure vessel (hereinafter, referred to as RPV) 2, a core 5, a core shroud 7, a jet pump 9, steam separators 10, and a steam drier 11. The RPV 2 has a bottom head 4 formed on a bottom and an upper head 3 removably attached to an upper end. The core 5, the core shroud 7, the jet pump 9, the steam separators 10, and the steam drier 11 are disposed in the RPV 2. The core 5 in which a plurality of fuel assemblies 6 loaded is surrounded by the cylindrical core shroud 7. The core shroud 7 is supported by an inner surface of the RPV 2 due to core shroud support structures 12 and 13. A core support plate 8 is disposed in the core shroud 7, is attached to the core shroud 7, and supports a lower end of each of the fuel assemblies 6 loaded in the core 5. A plurality of jet pumps 9 are disposed in a down comer 20 which is an environmental region formed between the inner surface of the RPV 2 and an outer surface of the core shroud 7 and are installed on the core shroud support structure 13. The steam separators 10 are disposed above the core 5 and is attached to a shroud head installed at the upper end of the core shroud 7. The steam drier 11 is disposed above the steam separator 10.

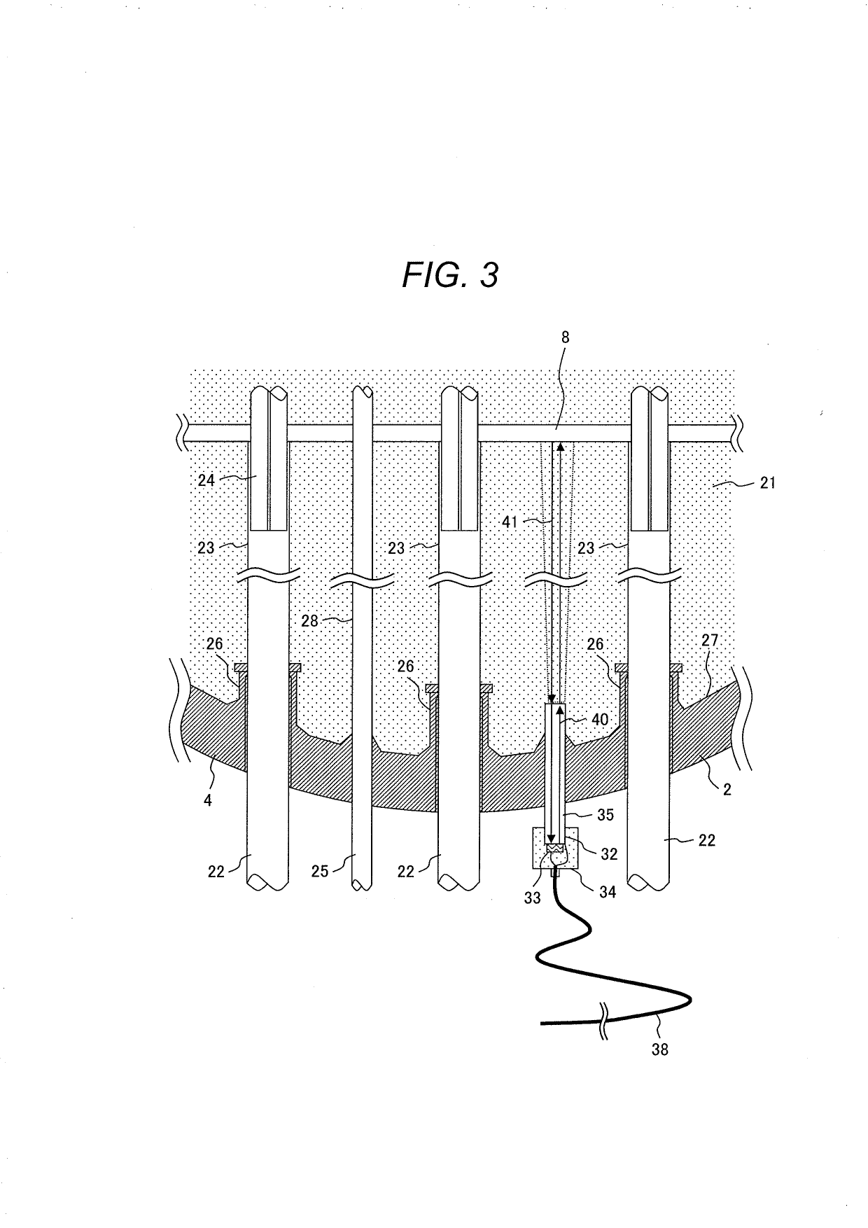

A cladding layer 27 formed by welding of stainless steel or nickel-base alloy is internally lined on the inner surface of the RPV 2 (refer to FIG. 3). A plurality of control rod guide pipes 23 and a plurality of incore instrumentation guide pipes 28 are arranged in a lower plenum 21 which is a region existing below the core support plate 8 in the RPV 2. A plurality of stub tubes 26 are installed on the bottom head 4 of the RPV 2. A plurality of control rod drive mechanism housings 22 separately attached to the respective stub tubes 26 penetrate the stub tubes 26 and the bottom head 4. A plurality of incore instrumentation pipe housings 25 penetrate the bottom head 4. Each of the control rod guide pipes 23 is installed at the upper end of each of the control rod drive mechanism housings 22. A control rod 24 is disposed in each of the control rod guide pipes 23 and is connected to each control rod drive mechanism (not shown) installed in each of the control rod drive mechanism housings 22. The incore instrumentation guide pipes 28 are connected to the incore instrumentation pipe housings 25.

A differential pressure type water level gauge 14 is disposed outside the RPV 2 and is installed in the RPV 2. The differential pressure type water level gauge 14 is provided with a condenser 15, a differential pressure gauge 16, an upper instrumentation pipe 17, an instrumentation pipe 18, and a lower instrumentation pipe 19. The condenser 15 is disposed outside the RPV 2 and inside the reactor containment vessel 114. The upper instrumentation pipe 17 is connected to the RPV 2 in the neighborhood of the steam drier 11 and is also connected to the condenser 15. The differential pressure gauge 16 is disposed outside the reactor containment vessel 114 and is connected to the condenser 15 by the instrumentation pipe 18. The lower instrumentation pipe 19 is connected to the RPV 2 in the neighborhood of the core lower support plate 8. The differential pressure gauge 16 is also connected to the lower instrumentation pipe 19.

In the differential pressure type water level gauge 14, the steam in the RPV 2 flows into the condenser 15 through the upper instrumentation pipe 17 and is condensed, so that the standard water level is formed in the condenser 15. By dong this, to the differential pressure gauge 16, the pressure of the sum of the water in the instrumentation pipe 18 and the standard water level in the condenser 15 is added. The lower instrumentation pipe 19 gives the water pressure corresponding to the water level of cooling water (hereinafter, referred to as reactor water) in the RPV 2 at a position in the neighborhood of the core support plate 8 to the differential pressure gauge 16. The differential pressure type reactor water level gauge 14 converts the change in the pressure difference in correspondence with the water level change in the RPV 2 measured by the differential pressure gauge 16 to a water level and measures the water level.

The reactor bottom area monitoring apparatus used in the method of monitoring reactor bottom area of the present embodiment will be explained by referring to FIGS. 1 and 3. The reactor bottom area monitoring apparatus has an ultrasonic sensor 32, an ultrasonic transmitter and receiver 36, and a remote display apparatus 37. The ultrasonic sensor 32 includes a sensor leading edge portion 35 which is a round rod made of a reactor structural material such as stainless steel or nickel-base alloy and a piezo-electric element (ultrasonic vibration element) 33. The reason that the sensor leading edge portion 35 is produced with a reactor structural material such as stainless steel or nickel-base alloy is to obtain the material strength and long term stability. A center axial of the sensor leading edge portion 35 is arranged so as to be parallel with a center axial of the RPV 2. The piezo-electric element 33 is disposed outside the RPV 2 and attached to one end surface of the sensor leading edge portion 35. A radiation shielding case 34 is attached to one end portion of the sensor leading edge portion 35 and covers the piezo-electric element 33. The one end portion of the sensor leading edge portion 35 is disposed outside the RPV 2. A signal line 38 connected to the piezo-electric element 33 is connected to the ultrasonic transmitter and receiver 36. The remote display apparatus 37 is connected to the ultrasonic transmitter and receiver 36.

The sensor leading edge portion 35 penetrates the bottom head 4 and is attached to the bottom head 4 by welding. Another end portion of the sensor leading edge portion 35 is disposed between the stub tubes 26 in the RPV 2. In the case of the already-existing boiling water reactor 1, the attachment of the sensor leading edge portion 35 to the bottom head 4 is performed after the cooling water in the RPV 2 is discharged from the drain pipe connected to the bottom head 4 and during the period of the periodic inspection when the operation of the boiling water reactor 1 is stopped. The attachment of the sensor leading edge portion 35 to the bottom head 4 is performed using the holes for the incore instrumentation pipe housings 25 which are formed in the bottom head 4. In the already-existing boiling water reactor 1, the cooling water is filled in the RPV 2 after the sensor leading edge portion 35 is attached to the bottom head 4 and before operation of the boiling water 1 reactor is started. In the case of a newly-built boiling water reactor 1, the sensor leading edge portion 35 is attached to the bottom head 4 of a newly produced RPV 2.

The piezo-electric element 33 attached to the one end surface of the sensor leading edge portion 35 is disposed outside the RPV 2. As the piezo-electric element 33, a piezo-electric element which has a curie temperature of 300° C. or higher and can operate in a high-temperature environment is used. The piezo-electric element 33 is composed of, for example, one kind of material among lead titanate (PbTiO₃), lead zirconate titanate (Pb(Zrₓ, Ti₁-ₓ)O₃), lithium niobate (LiNbO₃), potassium niobate (KNbO₃), bismuth titanate (Bi₄Ti₃O₁₂), gallium phosphate (GaPO₄), and aluminum nitrate (AlN) or a mixture of these materials. Further, the piezo-electric element 33 is covered with the radiation shielding case 34 to prevent the piezo-electric element 33 from being irradiated with strong radiation generated during the operation of the boiling water reactor 1.

The ultrasonic transmitter and receiver 36 includes a pulser receiver 56 for applying a voltage to the piezo-electric element 33 of the ultrasonic sensor 32 as well as converting a received signal of the piezo-electric element 33 to a voltage and recording it, and a signal processing apparatus 57 for performing signal processing such as filtering the received signal input in the pulser receiver 56. The signal line 38 connected to the piezo-electric element 33 is connected to the pulser receiver 56 and the signal processing apparatus 57 is connected to the pulser receiver 56. The remote display apparatus 37 includes a communication device 58 connected to the signal processing apparatus 57, and a display unit 59 for displaying monitoring results in a remote place such as a central processing room and connected to the communication device 58.

Since the sensor leading edge portion 35 penetrates the bottom head 4 and is installed on the bottom head 4 of the RPV 2, a boundary layer with different acoustic impedance (sound speed multiplied by density) which is a reflection source of ultrasonic waves does not exist in the ultrasonic propagation path from the ultrasonic sensor 32 to the reactor water in the lower plenum 21. Therefore, the loss in the boundary layer is eliminated and the ultrasonic waves can be propagated efficiently in the reactor water.

In the bottom head 4 of the RPV 2, as described above, the plurality of stub tubes 26 and the plurality of incore instrumentation pipe housings 25 exist and the bottom head 4 is a welded structure in a complicated shape having a plurality of curved surfaces. Furthermore, the inner surface of the RPV 2 is internally lined with the cladding layer 27. Therefore, merely installing the ultrasonic sensor on the outer surface of the bottom head 4 causes a necessity to make ultrasonic waves pass through the welded structure and the curved shape and to receive them, so that the reflection of ultrasonic waves on the boundary portion and the scattering attenuation of ultrasonic waves on the welded portion become a factor of sensitivity reduction of the ultrasonic sensor. Furthermore, the boiling water reactor is followed by the temperature change from the room temperature at the time of start to the temperature (300° C.) during the rated operation. The low alloy steel, stainless steel, and nickel-base alloy of the RPV 2, and reactor water in the RPV 2 which is a medium through which ultrasonic waves are propagated are changed in the sound speed depending on the temperature.

The sound speed change of soft steel is about 4% in the temperature change from the room temperature to 300° C., as described in IIC REVIEW/2009/10, No. 42, pp. 39. Further, as described in 1999 Japan Society of Mechanical, Steam Table BASED ON IAPWS-IF97, pp. 128-129, particularly, the sound speed of the reactor water of the boiling water reactor is changed by as much as about 37% from 1531 m/s to 970 m/s during temperature rise from 40° C. at the end time of the under-sharing inspection to 300° C. at the rated operation.

Therefore, in accordance with the aforementioned sound speed change, for example, assuming that the ultrasonic sensor is installed on the outer surface of the bottom head 4 of the RPV 2 during an inservice inspection period, the angle of refraction of the ultrasonic waves transmitted from the ultrasonic sensor installed on the outer surface of the RPV 2 on the curved surface of the bottom head 4 is changed with the temperature under the condition having a temperature change when the reactor is in operation and during the rated operation at about 300° C. The refraction of the ultrasonic waves follows the Snell's law indicated by Formula (1).

sin θ_{A}/sin θ_{B}−v_{A}/v_{B} (1)

where V_{A} is wave speed in the medium A, V_{B} is wave speed in the medium B, θ_{A} is an incident angle from the medium A to the medium B, and θ_{B} is an incident angle from the medium B to the medium A. As described above, merely installing the ultrasonic sensor on the outer surface of the RPV 2 causes the angle of refraction to change in correspondence with the temperature change, and makes it difficult to catch the reflected waves from the reflection source. As a consequence, the SN ratio in monitoring of the reactor bottom area reduces.

Therefore, in the present embodiment, the water level in the RPV 2 is measured by avoiding the passing of the ultrasonic waves through the welded portion and curved surface and furthermore, using the ultrasonic waves propagated in the axial direction of the RPV 2 which does not need to consider the influence of refraction of the ultrasonic waves in order to reduce the influence of the sensitivity reduction due to the refraction of ultrasonic waves in correspondence with temperature changes of the welded portion, curved surface, and sound speed. Concretely, since the sensor leading edge portion (for example, the round rod) 35 extending in the axial direction of the RPV 2 penetrates the bottom head 4 and is installed on the bottom head 4, the ultrasonic waves generated by the piezo-electric element 33 do not pass through the RPV 2 and the cladding layer 27, are propagated to the sensor leading edge portion 35, and are transmitted to the reactor water in the lower plenum 21.

When the boiling water reactor 1 is in operation, the reactor water in the lower plenum 21 is supplied from the underneath into each of the fuel assemblies 6 loaded in the core 5, and is heated by the heat generated by nuclear fission of a nuclear fuel material included in the fuel assemblies 6, and a part thereof becomes steam. The gas-liquid two-phase flow including the steam and reactor water is introduced into the steam separator 10 and the steam is separated from the reactor water in the steam separator 10. The moisture included in the separated steam is removed by the steam drier 11. The steam discharged from the steam drier 11 is discharged from the RPV 2 into the main steam pipe and is supplied to the steam turbine (not shown).

A voltage is applied to the piezo-electric element 33 from the puller receiver 56 of the ultrasonic transmitter and receiver 36, thus the piezo-electric element 33 vibrates and generates ultrasonic waves. The ultrasonic waves 40 are propagated inside the sensor leading edge portion 35 and are propagated to the reactor water in the lower plenum 21 from the sensor leading edge portion 35 (see FIG. 3). When the RPV 2 is filled with reactor water, the ultrasonic waves 40 propagated in the reactor water are reflected on the core support plate 8. The reflected ultrasonic waves 41 follow the same path, enter the sensor leading edge portion 35, are propagated inside the sensor leading edge portion 35, and are received by the piezo-electric element 33. The piezo-electric element 33 outputs a received signal of the reflected ultrasonic waves 41 to the pulser receiver 56 of the ultrasonic transmitter and receiver 36.

The signal processing apparatus 57 of the ultrasonic transmitter and receiver 36 obtains the reflected time position of the ultrasonic waves 40 using the received signal of the ultrasonic waves 41. The time position is monitored by the remote display apparatus 37, thus whether the reactor water is filled up to the position of the lower surface of the core support plate 8 in the RPV 2 or not can be confirmed. When the reactor water is filled up to the position of the lower surface of the core support plate 8 in the RPV 2, the water level in the RPV 2 is measured by the differential pressure type water level gauge 14. The water level control in the RPV 2 and the water level monitoring in the RPV 2 are performed based on the water level measured by the differential pressure type water level gauge 14.

A leading edge portion of the sensor leading edge portion 35 positioned inside the RPV 2 may have a concave geometrical curved surface shape. Generally, ultrasonic waves are propagated in a fixed spread, so that even when a leading edge of the sensor leading edge portion 35 positioned in the RPV 2 is flat, the ultrasonic waves transmitted from the leading edge thereof have a spread at a certain extent, that is, are diffused. The concave geometrical curved surface shape is formed at the leading edge portion thereof, thus the influence of the diffusion of the ultrasonic waves can be reduced. In this case, for example, the concave geometrical curved surface is formed at the leading edge portion of the sensor leading edge portion 35 based on the distance up to the core support plate 8, thus the sensitivity reduction due to the diffusion of the ultrasonic waves can be prevented by the influence of the curved surface lens. The curved surface formed at the leading edge portion of the sensor leading edge portion 35 is hollowed toward the end surface side of the sensor leading edge portion 35 to which the piezo-electric element 33 is attached.

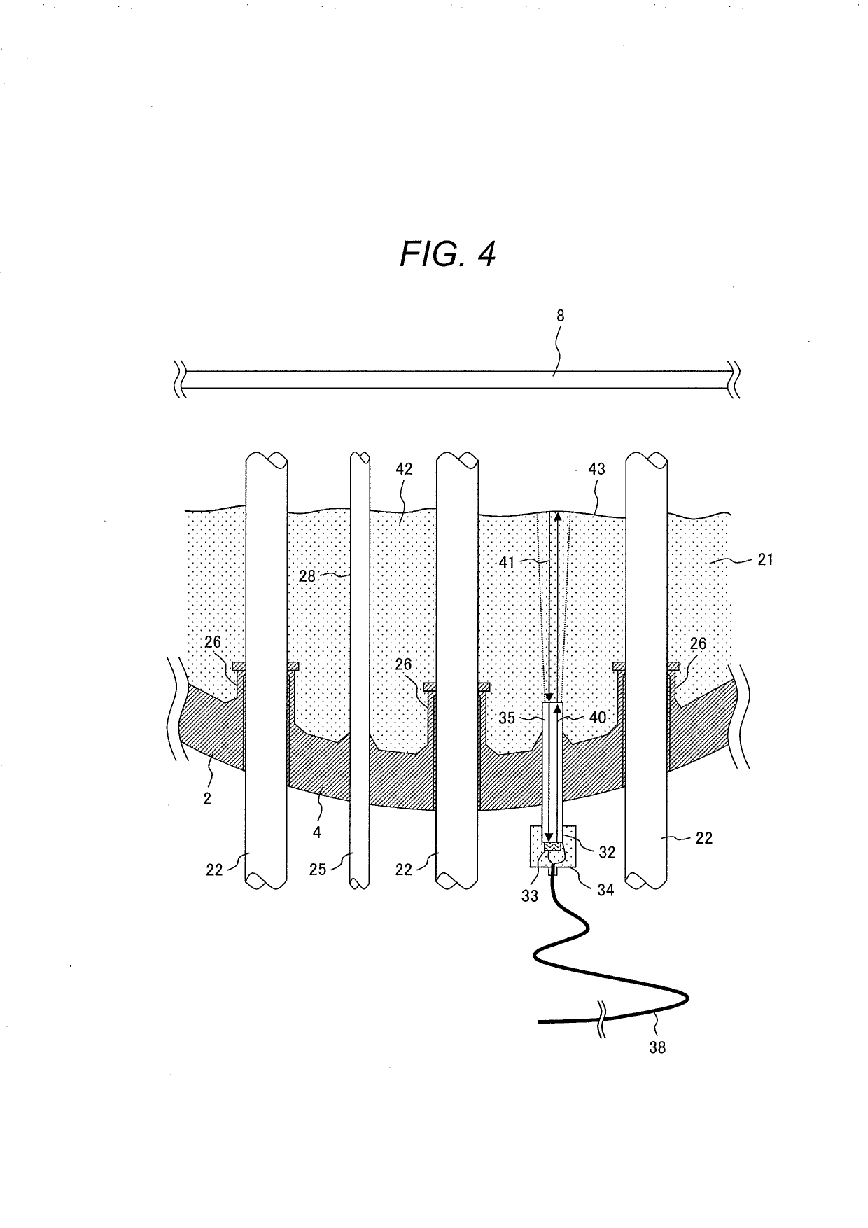

It is supposed that a certain accident occurs and the reactor water level in the RPV 2 is reduced below the core support plate 8. The state is shown in FIG. 4. The water level of reactor water 42 in the lower plenum 21 is reduced below the core support plate 8 and a water surface 43 of the reactor water 42 is formed below the core support plate 8 and in the lower plenum 21 (see FIG. 4). The ultrasonic waves 40 generated by the piezo-electric element 33 pass through the sensor leading edge portion 35, are propagated to the reactor water 42, and reach the water surface 43. Air or steam exists above the water surface 43. The reactor water 42 and air (or steam) are greatly different in the acoustic impedance (sound speed multiplied by density), so that the ultrasonic waves are reflected almost totally on the water surface 43 of the reactor water 42. By doing this, the ultrasonic waves 41 reflected on the water surface 43 follow the same path and are propagated in the reactor water 42 toward the sensor leading edge portion 35. The ultrasonic waves 41, furthermore, are propagated to the sensor leading edge portion 35 and are received by the piezo-electric element 33. As described above, the received signal of the ultrasonic waves 41 which is output from the piezo-electric element 33 is output to the ultrasonic transmitter and receiver 36 and the time position is obtained. The time position of the reflected waves of the ultrasonic waves is monitored by the remote display apparatus 37, thus the position of the water surface 43 can be obtained.

Further, when the water surface 43 shakes, the reflection angle of the ultrasonic waves is not stabilized due to the shake and there is found a case in which the reflection from the water surface 43 is hardly received. Therefore, in the signal processing apparatus 57 of the ultrasonic transmitter and receiver 36, the reflected waves of ultrasonic waves from the water surface 43 can be detected easily by performing multi-display processing in which multiple recorded waveforms of ultrasonic waves are overlayed and displayed or frequency filtering for reducing noise.

Next, the difference in the waveform of the reflected ultrasonic waves 41 which is received by the piezo-electric element 33 when the water level of the reactor water in the RPV 2 exist in the normal state (when the underneath of the core support plate 8 is filled with the reactor water) and the water level of the reactor water in the RPV 2 is reduced to the underneath of the core support plate 8 will be explained.

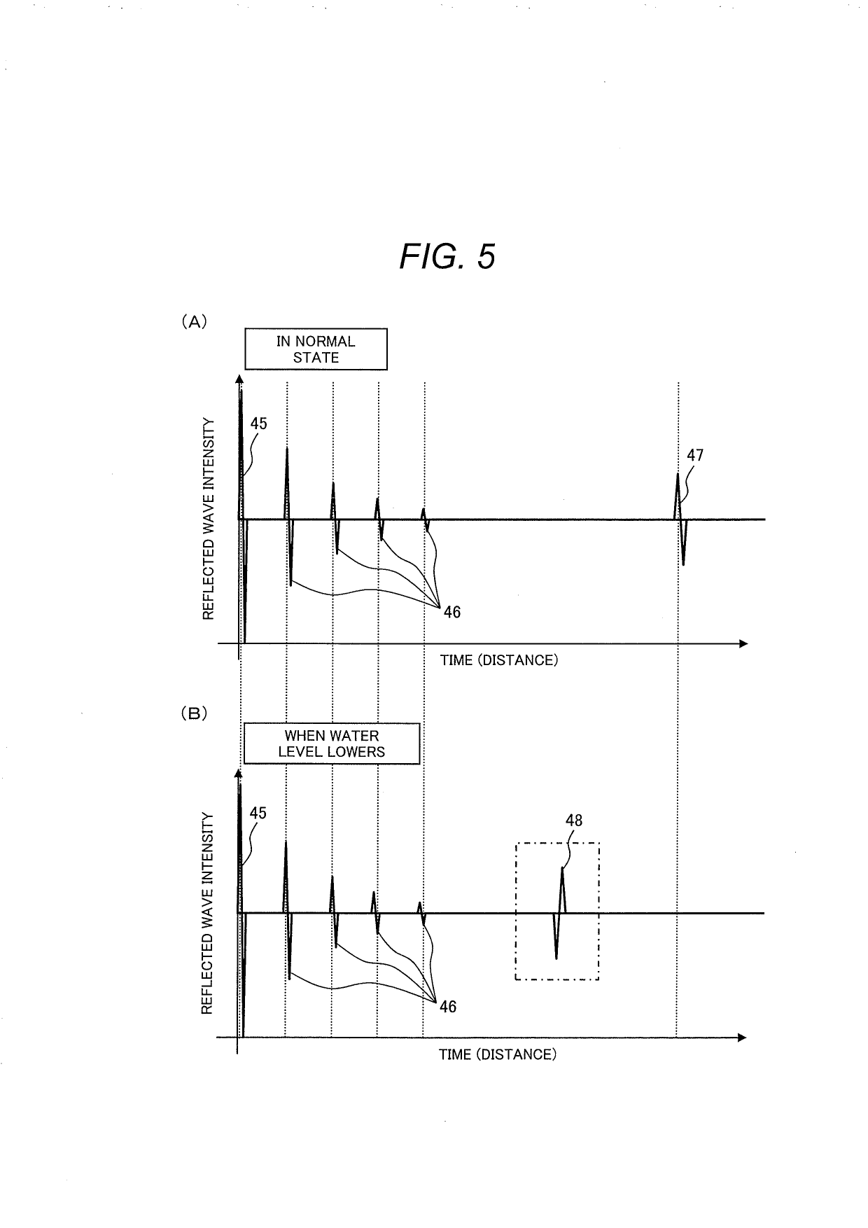

(A) of FIG. 5(A) shows the waveform of the ultrasonic waves 41 reflected in the normal state of the water level of the reactor water in the RPV 2. In (A) of FIG. 5, a horizontal axis indicates the time (a distance is obtained by multiplying the time by the sound speed) and a vertical axis indicates intensity of the reflected waves. When the ultrasonic waves are transmitted from the ultrasonic sensor 32, transmission noise 45 at the time of transmission is first measured and then multiple reflected waves 46 inside the sensor leading edge portion 35 are measured. The time interval between the transmission noise 45 and the multiple reflected waves 46 depend upon the sound speed and the temperature at the time of measurement of stainless steel or nickel-base alloy which are the materials of the sensor leading edge portion 35. Therefore, the sound speed inside the sensor leading edge portion 35 is obtained based on the length of the sensor leading edge portion 35 and the time interval of the multiple reflected waves and the temperature in the neighborhood of the sensor leading edge portion 35 can be obtained by the table of sound speed and temperature which is separately prepared. These calculations are performed by the signal processing apparatus 57 of the ultrasonic transmitter and receiver 36. Further, the temperature in the neighborhood of the sensor leading edge portion 35, as another means, may be measured by disposing a thermocouple. Further, whenever the multiple reflected waves are reflected on the boundary surface between the sensor leading edge portion 35 and the reactor water 42, since a part thereof is propagated into the reactor water, the intensity of the multiple reflected waves 46 is reduced slowly. By observation of the multiple reflected waves 46, whether the ultrasonic sensor 32 operates soundly or not can be confirmed. Furthermore, reflected waves 47 from the core support plate 8 are measured in the normal state that the RPV 2 is filled with reactor water. The reflected waves 47 are reflected waves from the reactor internal which is a stopped reflection source, so that they can be measured stably. Further, since the acoustic impedance (sound speed multiplied by density) of the reactor internal is larger than that of the reactor water 42, so that the phase of the waveform of the ultrasonic waves is not inverted.

However, when the water level of the reactor water 42 is lowered to below the core support plate 8, the reflected waves 47 from the core support plate 8 shown in (A) of FIG. 5 cannot be obtained and at an earlier time position than it, reflected waves 48 from the water surface 43 can be obtained (see (B) of FIG. 5). (B) of FIG. 5 shows the waveform of the ultrasonic waves 41 reflected at the time of water level reduction that the water level of the reactor water is lowered to below the core support plate 8. The distance from the leading edge of the sensor leading edge portion 35 to the water surface 43 can be obtained by obtaining the aforementioned time position of the reflected waves 48, by obtaining a time difference between the reflected waves 48 and the initial reflected waves (first reflected waves) among the multiple reflected waves 46 from the sensor leading edge portion 35 based on the time position, and further by multiplying the time difference by the sound speed of the reactor water 42. These calculations are performed by the signal processing apparatus 57 of the ultrasonic transmitter and receiver 36. Further, in that case, the acoustic impedance (sound speed multiplied by density) of air and steam is smaller than that of the reactor water 42, so that the phase of the ultrasonic waveform is inverted by 180°. Namely, assuming that the ultrasonic reflected waves 47 from the core support plate 8 have a waveform rising from positive, the ultrasonic reflected waves 48 from the water surface 43 have a waveform rising from negative. As described above, the characteristics of the reflection source can be known from the phase of the reflected waves, depending on whether the acoustic impedance of the reflection source is larger or smaller compared with that of the reactor water.

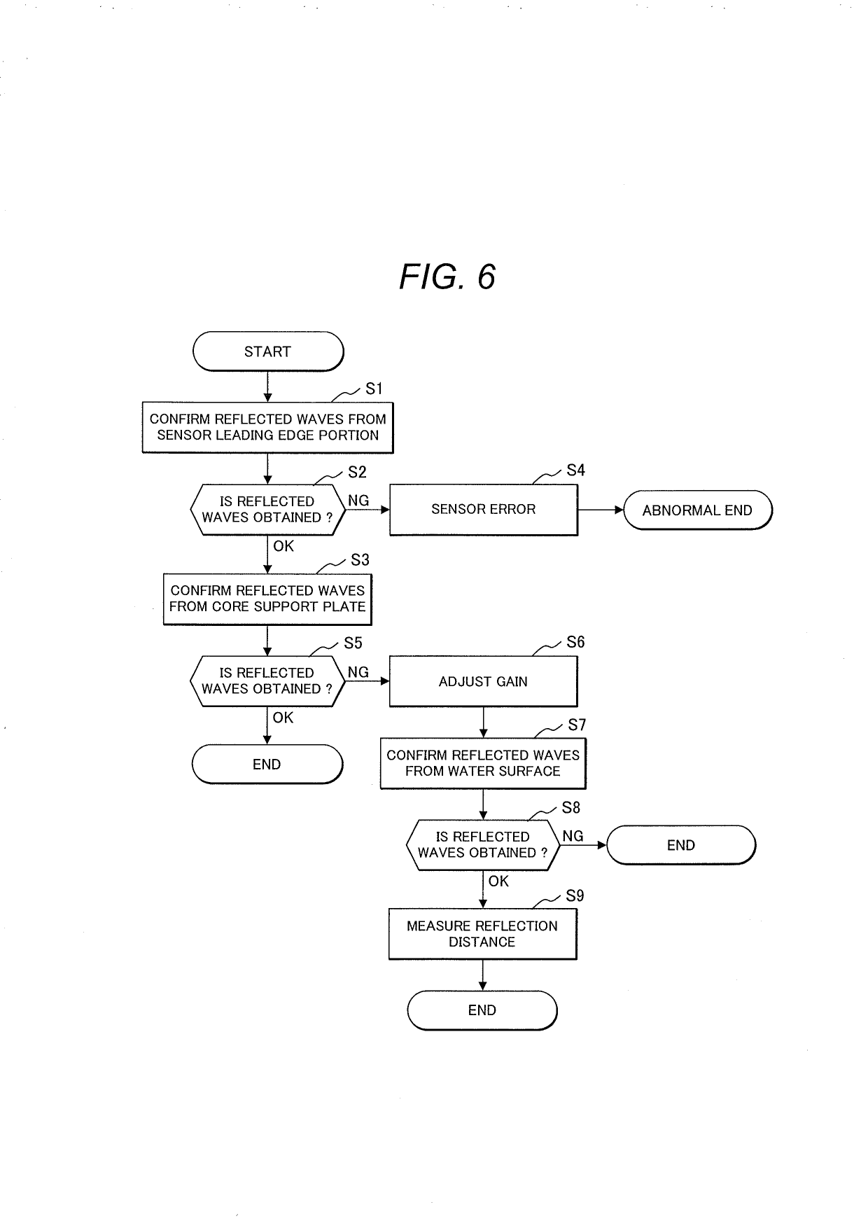

Next, measurement flow of the method of monitoring reactor bottom area of the present embodiment will be explained by referring FIG. 6. The measurement is started and firstly, the reflected waves from the sensor leading edge portion 35 are confirmed (Step S1). In the decision of the confirmation of the reflected waves (Step S2), when “NG”, that is, “No reflected waves can be obtained.” is decided, it is discriminated that a sensor error such as the ultrasonic sensor 32 itself being out of order is caused (Step S4). If an abnormality occurs in the ultrasonic sensor 32 itself, the measurement using the reactor bottom area monitoring apparatus is finished.

When the decision of Step S2 is “OK”, that is, it is decided that the reflected waves from the sensor leading edge portion 35 can be obtained, the ultrasonic sensor 32 is judged to be normal. Next, the reflected waves from the core support plate 8 are confirmed (Step S3). As shown in FIG. 5, the core support plate 8 is a fixed reactor internal, so that the time position of the reflected waves thereof may be shifted due to the sound speed changes of the sensor leading edge portion 35 and the reactor water 42. However, the reflected waves can be measured always at the same distance by correcting the sound speed based on the temperatures of the sensor leading edge portion 35 and the reactor water 42. When it is decided by the confirmation decision (Step S5) of the reflected waves that the reflected waves can be obtained, that is, “OK” is decided, the underneath of the core support plate 8 in the RPV 2 is filled with the reactor water, so that the measurement using the reactor bottom area monitoring apparatus is finished.

However, when the reflected waves cannot be obtained and the decision at Step S5 is “NG”, whether there exist reflected waves at the time position before the reflected waves 47 from the core support plate 8 or not is confirmed. At that time, the gain of the pulser receiver 56 of the ultrasonic transmitter and receiver 36 is adjusted (Step S6), thus the reception sensitivity of reflected waves may be improved. As described above, this is effective in the case that the reflected waves of the ultrasonic waves are hardly caught due to the shaking of the water surface 43. As described above, after the gain is adjusted, the reflected waves below the core support plate 8 are confirmed (Step S7). When the confirmation decision (Step S8) of the reflected waves is “NG”, that is, when the reflected waves cannot be measured, due to other factors such as the state that the reactor water 42 does not exist in the RPV 2 or fallen parts exists below the core support plate 8 in the RPV 2, the reflected waves cannot be measured. When the decision at Step S8 is “OK”, that is, when the reflected waves below the core support plate 8 can be confirmed, the distance up to the reflection position is measured by the aforementioned method (Step S9) and the water level in the RPV 2, that is, the water level in the lower plenum 21 is measured.

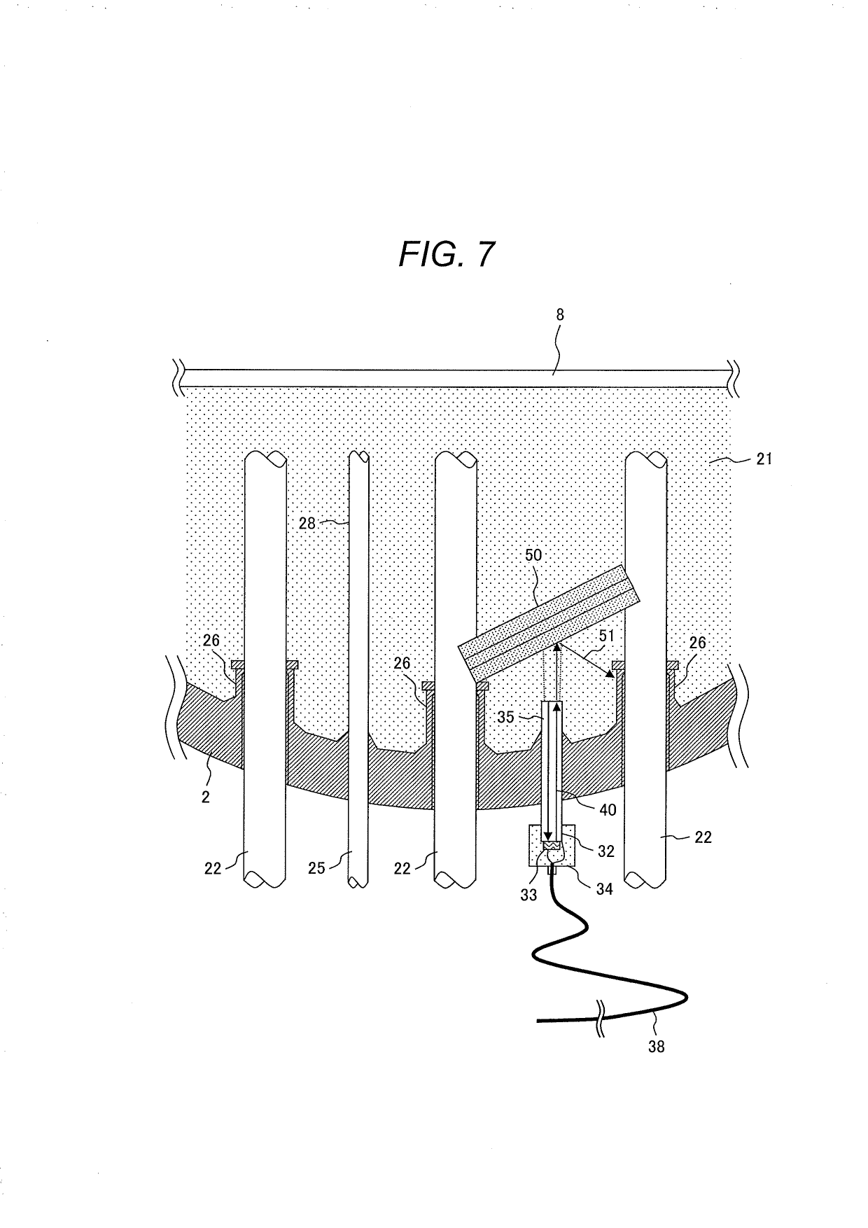

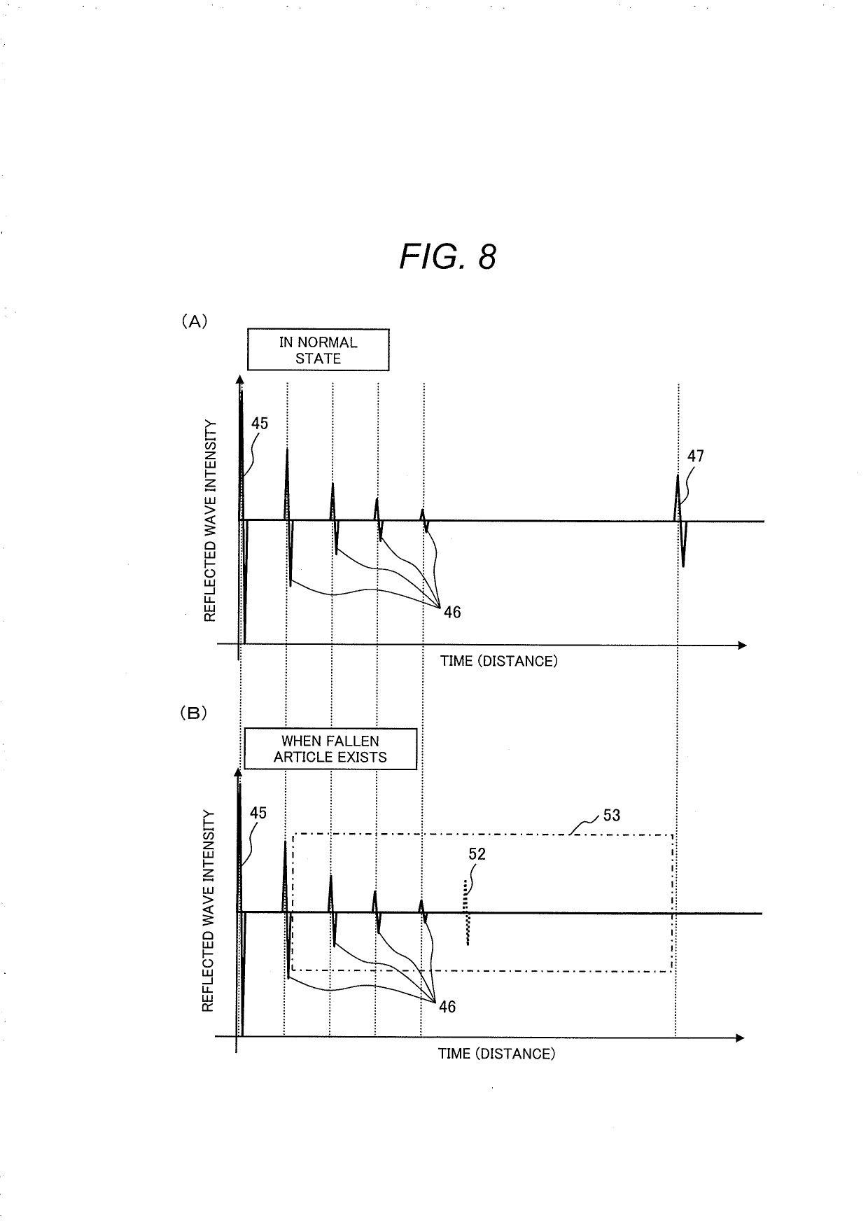

The measurement of fallen parts 50 when the fallen parts 50 exists below the core support plate 8 in the RPV 2 will be explained by referring to FIGS. 7 and 8. When the fallen parts 50 exists in the lower plenum 21, the reflection state of the ultrasonic waves in the reactor water is different compared with the case of the water level reduction of the reactor water explained by referring to FIG. 4. For example, when the fallen parts 50 is a metallic part as shown in FIG. 7, the ultrasonic waves propagated from the sensor leading edge portion 35 to the reactor water are reflected as reflected waves 51 at an angle corresponding to the incident angle to the fallen parts 50. Therefore, the ultrasonic waves 51 may not be received by the ultrasonic sensor 32, that is, the piezo-electric element 33 depending on the relative angle between the ultrasonic waves propagated from the sensor leading edge portion 35 to the reactor water and the fallen parts 50. Therefore, in the reflected waveform when the fallen parts 50 shown in (B) of FIG. 8 exists, the reflected waves 47 (see (A) of FIG. 8) by the core support plate 8 are not measured. Further, in (A) of FIG. 8 showing the received waveform of ultrasonic waves in the normal state that the fallen parts 50 does not exist, the received waveform is similar to the one shown in (A) of FIG. 5.

In addition, in a time domain 53 before the reflected waves 47 by the core support plate 8, the reflected waves from the fallen parts 50 cannot be measured, though only when an angle of a reflection surface of the fallen parts 50 and the ultrasonic propagation angle coincide with each other by chance, reflected waves 52 from the fallen parts 50 can be measured. When the fallen parts 50 exists in this way, in combination with not only the reflected signal received by the piezo-electric element 33 but also another measuring means such as an indicated value of the differential pressure type water level indicator 14, the factor for not being able to obtain the reflected waves from the core support plate 8 is analyzed and the safety of the reactor is confirmed. Further, when the reflected waves 52 from the fallen parts 50 can be measured, the magnitude of the acoustic impedance compared with the reactor water is discriminated based on a phase change of the reflected waves and weather it is metal, air, or steam can be discriminated.

In the present embodiment, using the hole for the incore instrumentation pipe housings 25 formed in the bottom head 4, the sensor leading edge portion 35 is installed on the bottom head 4 of the RPV 2 by penetrating it, and a pressure boundary by welding or a flange structure is formed, and the ultrasonic waves are transmitted or received by being propagated from the piezo-electric element 33 of the ultrasonic sensor 32 to the sensor leading edge portion 35 toward the core support plate 8, thus the reflected waves are measured, and the state beginning with the water level existing below the core support plate 8 can be monitored. Therefore, unlike the conventional technique, the complication of the reactor structure due to the additional installation of an instrumentation pipe can be canceled.

Since the sensor leading edge portion 35 is installed on the bottom head 4 of the RPV 2 by penetrating it, the ultrasonic waves are propagated efficiently in the reactor water and can be transmitted and received without affected by the welded structures such as the cladding layer 27 on the inner wall of the RPV 2, the stub tubes 26, and the incore instrumentation pipe housings 25, furthermore, the curved surfaces and the as-built shapes of these welded structures. Therefore, highly reliable measurement at a high SN ratio can be performed.

Further, the end surface of the sensor leading edge portion 35 on the side of the core support plate 8 is formed in a lens structure in a curved surface shape, thus the sensitivity reduction due to the diffusion attenuation of the ultrasonic waves propagated in the reactor water is prevented, and since there exists a radiation shield around the piezo-electric element 33 for forming the ultrasonic sensor 32, the SN ratio can be improved more, and the sensitivity reduction of the ultrasonic sensor due to radiation of the bottom head 4 can be prevented, and stable monitoring can be performed for a long period of time.

Further, in the present embodiment, the reflected signal from the core support plate 8 is monitored, and existence of the signal is discriminated, and an ultrasonic signal reflected in a shorter time than the reflected signal from the core support plate 8 is monitored, thus the ultrasonic reflection position can be identified, so that the evaluation of the ultrasonic signal and the identification of the reflection position can be performed easily.

Furthermore, existence of the multiple reflected signal of ultrasonic waves in the sensor leading edge portion 35 is confirmed, thus the soundness of the ultrasonic sensor 32 itself is confirmed, and the temperature of the measurement portion is obtained simultaneously from the time interval at the time of reception of the multiple reflected waves, and the sound speed of the reactor water is corrected, and the position identification accuracy of the reflection source can be improved.

### Embodiment 2

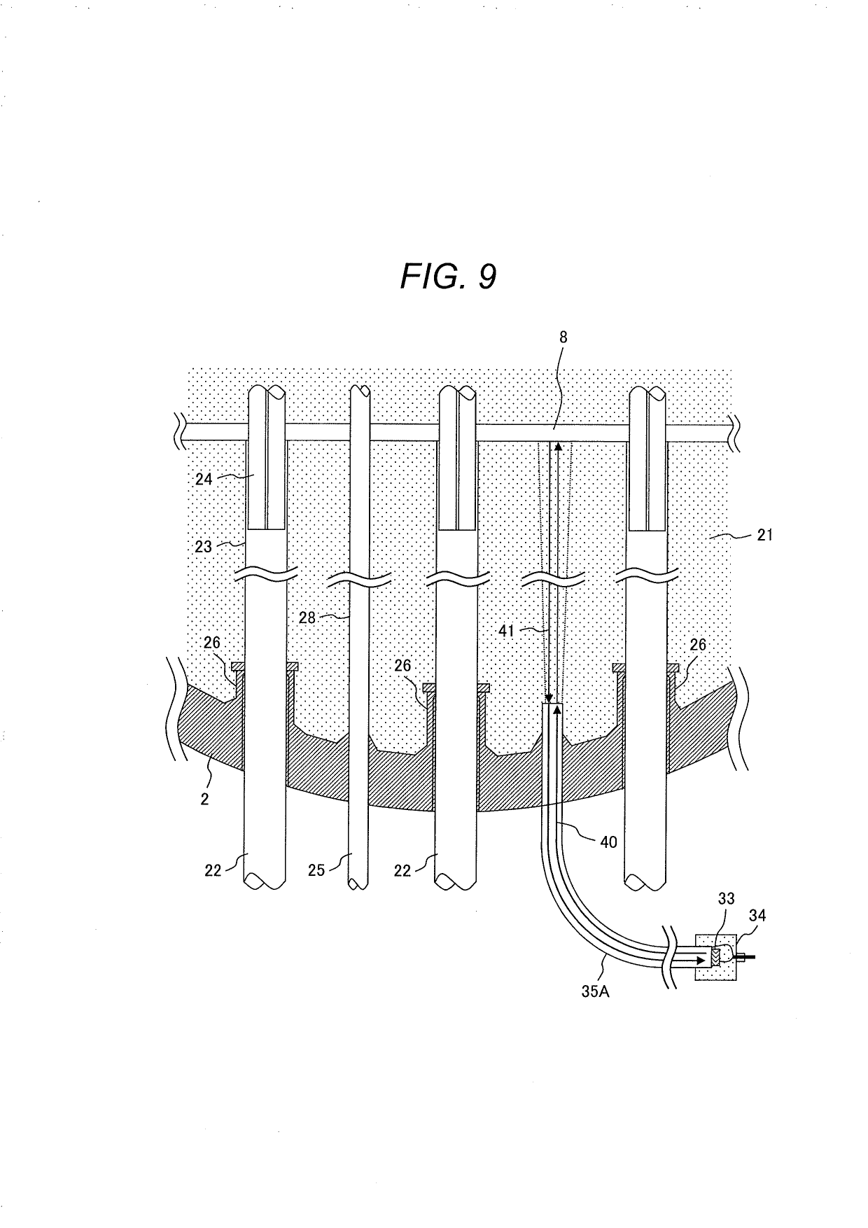

A method of monitoring reactor bottom area according to embodiment 2, which is another preferable embodiment of the present invention, applied to the boiling water reactor will be explained below by referring to FIG. 9.

The method of monitoring reactor bottom area of the present embodiment is applied when the temperature condition and radiation environment of the reactor bottom area are severe or the monitoring is executed for a long period of time. The reactor bottom area monitoring apparatus of the present embodiment has a structure that in the reactor bottom area monitoring apparatus used in embodiment 1, the sensor leading edge portion 35 is changed to a sensor leading edge portion 35A bent outside the RPV 2. The other structures of the reactor bottom area monitoring apparatus of the present embodiment are similar to those of the reactor bottom area monitoring apparatus of embodiment 1.

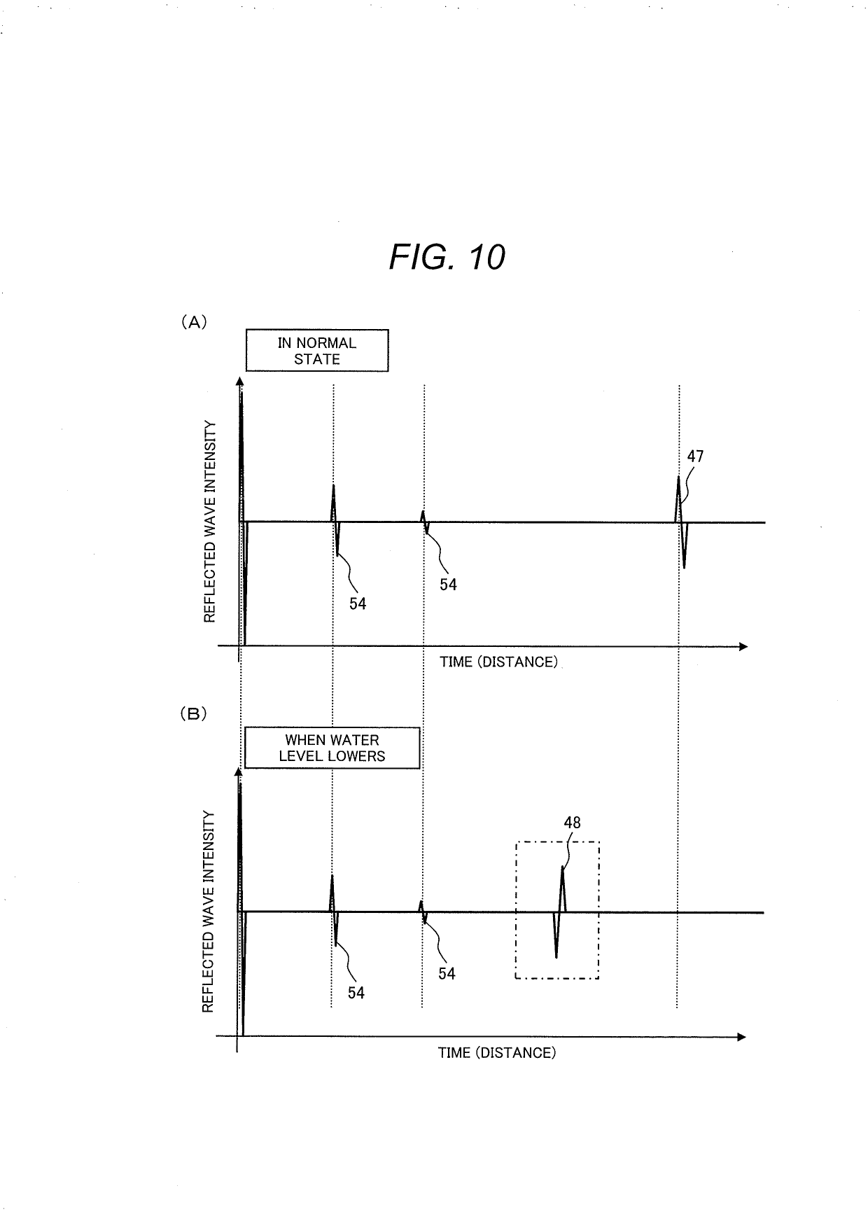

The sensor leading edge portion 35A has a structure that it is pulled out toward the outside of the RPV 2 and is further bent slowly. The reason is that the ultrasonic sensor 32, that is, the piezo-electric element 33 needs to be separated from such an environment as described above where the temperature condition and radiation environment are severe. Even if in a bent material, the ultrasonic waves generated by the piezo-electric element 33 has a characteristic of being propagated in the medium. Using the characteristic, the ultrasonic waves 40 are propagated to the sensor leading edge portion 35A from a distant place away from the RPV 2 and furthermore, are propagated to the reactor water. In this case, the radius of curvature of the slowly-bent sensor leading edge portion 35A is set to the radius of curvature of few reflections in the curved portion based on the frequency of the ultrasonic waves generated by the piezo-electric element 33, thus the loss inside the sensor leading edge portion 35A is designed so as to reduce. Even in this case, as the examples of the waveform are shown in (A) and (B) of FIG. 10, the time interval of multiple reflected waves 54 inside the sensor leading edge portion 35A will be spread by as much the length has become longer in the sensor leading edge portion 35A than that of the sensor leading edge portion 35 in embodiment 1. However, the soundness of the ultrasonic sensor 32 can be confirmed from the presence or absence of the multiple reflected waves 54, and the water level below the core support plate 8 can be measured based on the presence or absence of the reflected waves 47 from the core support plate 8, and the reflected waves 48 at the time position this side of the reflected waves 47, or the fallen parts 50 can be confirmed based on the presence or absence of the reflected waves 48. Incidentally, (A) of FIG. 10 shows the received waveform of ultrasonic waves 40 at the time of water level measurement of the boiling water reactor 1 in the normal state, and (B) of FIG. 10 shows the received waveform of ultrasonic waves 40 at the time of water level measurement at the time of water level reduction when the water surface 43 of cooling water exists below the core support plate 8. The confirmation method of the measurement of the water level and the existence of the fallen parts is similar to that of embodiment 1 aforementioned.

The present embodiment can obtain each effect generated in embodiment 1. The present embodiment uses the sensor leading edge portion 35A, so that even when the temperature condition and radiation environment of the reactor bottom area are severe and the monitoring is executed for a long period of time, the monitoring of the reactor bottom area can be executed.

### Embodiment 3

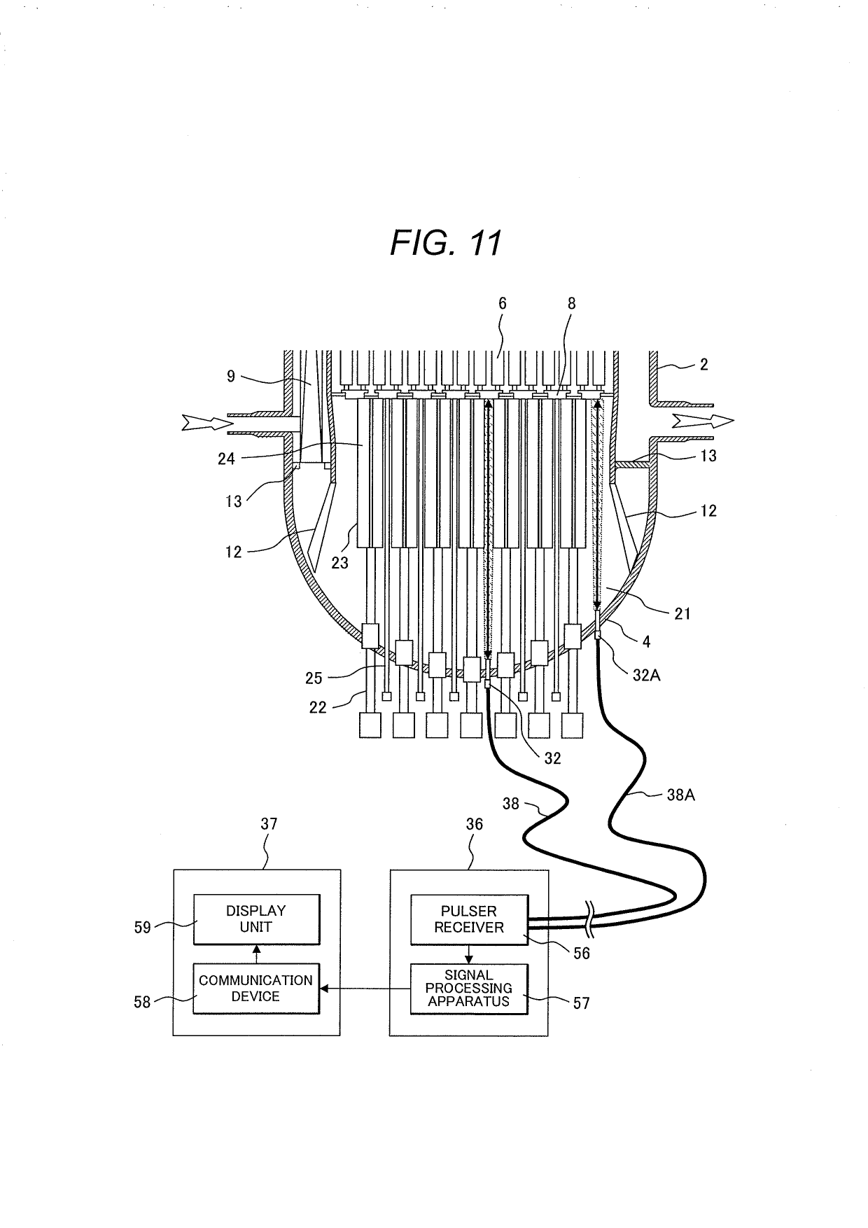

A method of monitoring reactor bottom area according to embodiment 3, which is another preferable embodiment of the present invention, applied to the boiling water reactor will be explained below by referring to FIG. 11.

The present embodiment improves the reliability of the measurement when measuring a reduction in the water level and existence of fallen parts. The method of monitoring reactor bottom area of the present embodiment uses a plurality of ultrasonic sensors. In the present embodiment, in addition to the ultrasonic sensor 32 used in embodiment 1, another ultrasonic sensor 32A having the similar structure to the ultrasonic sensor 32 is installed on the bottom head 4 of the RPV 2. The sensor leading edge portion 35 of the ultrasonic sensor 32A also penetrates the bottom head 4 and is installed on the bottom head 4. A signal line 38A connected to the piezo-electric element 33 of the ultrasonic sensor 32A is connected to the pulser receiver 56 the ultrasonic transmitter and receiver 36.

The present embodiment can obtain each effect generated in embodiment 1. Further, the present embodiment includes a plurality of ultrasonic sensors (32 and 32A) which penetrate the RPV 2 and are installed on it, so that whether the reflection source exists locally or uniformly exists overall the reactor bottom area can be confirmed.

### Embodiment 4

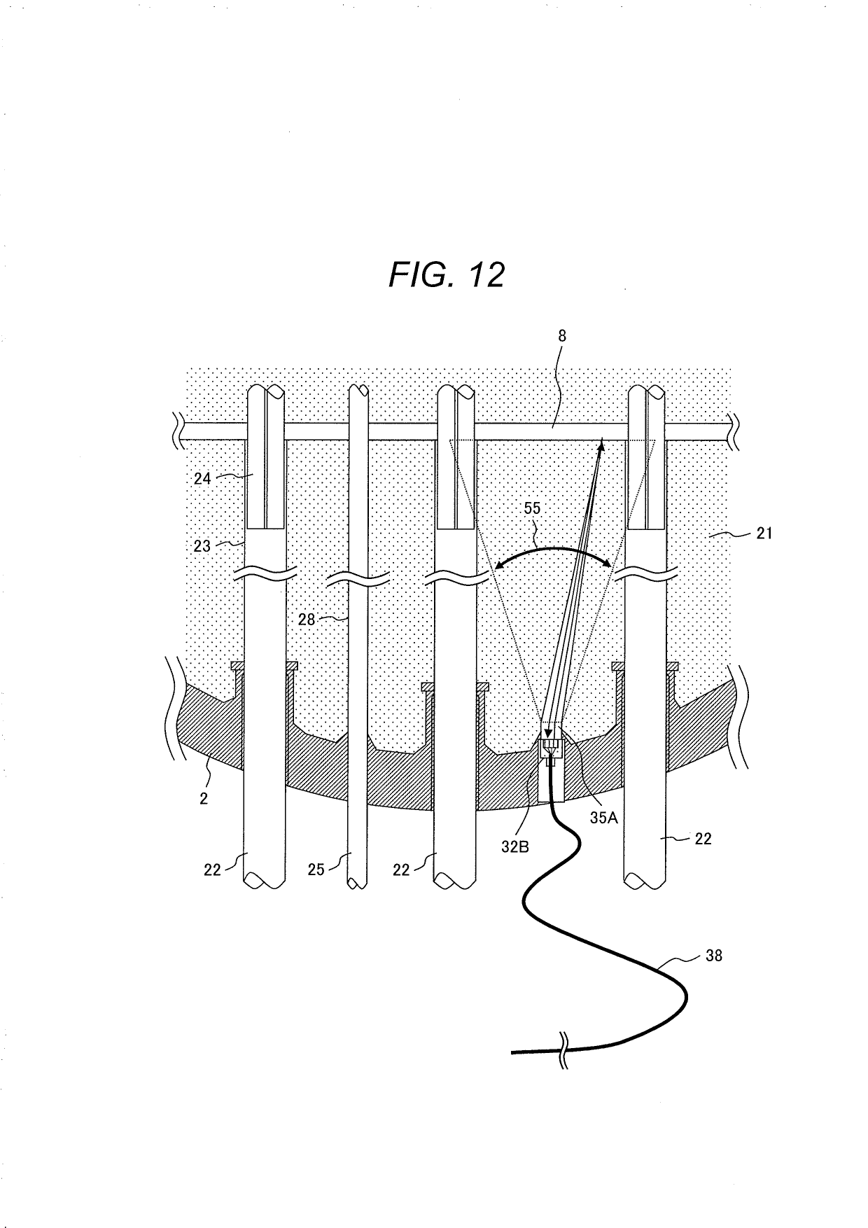

A method of monitoring reactor bottom area according to embodiment 4, which is another preferable embodiment of the present invention, applied to the boiling water reactor will be explained below by referring to FIG. 12.

The reactor bottom area monitoring apparatus used in the method of monitoring reactor bottom area of the present embodiment has a structure that in the reactor bottom area monitoring apparatus used in embodiment 1, the ultrasonic sensor 32 is changed to an array-type ultrasonic sensor 32B with a plurality of piezo-electric elements 33 structured in line. The ultrasonic sensor 32B has the sensor leading edge portion 35A. The sensor leading edge portion 35A is attached to the bottom head 4.

The array-type ultrasonic sensor, as generally known, is an ultrasonic sensor with piexo-electric elements arranged in a one-dimensional manner or two-dimensional (i.e., matrix or circular) manner. By use of the ultrasonic sensor 32B having such a characteristic, the ultrasonic waves are scanned electronically in the reactor water in the lower plenum 21 inside the RPV 2 and a sectional image in the reactor water can be obtained by the one-dimensional electronic scanning and three-dimensional information in the reactor water can be obtained by the two-dimensional electronic scanning.

However, as shown in embodiment 1, only by the attachment of the ultrasonic sensor to the outer surface of the RPV 2, as described above, it is difficult to monitor the inside of the RPV 2 due to the welded portion, the curved surface shape of the reactor bottom area, and furthermore, a change in the refraction angle due to a sound speed change in correspondence with a temperature change.

Therefore, in the method of monitoring reactor bottom area n of the present embodiment, similarly to aforementioned embodiments 1 to 3, the sensor leading edge portion 35A of the array-type ultrasonic sensor 32B is installed on the bottom head 4 by penetrating it by using the hole for the incore instrumentation pipe housings 25 formed on the bottom head 4, and a pressure boundary by welding and the flange structure is formed, and ultrasonic waves are transmitted and received toward the core support plate 8 from the ultrasonic sensors 32B, and furthermore, electronic ultrasonic wave scanning 55 is performed, thus the reflected waves are measured and the state beginning the water level below the core support plate 8 can be monitored. In this case, the ultrasonic waves are focused, transmitted, and received by using the array-type ultrasonic sensor in order to improve the SN ratio of the measured waveform. By doing this, a sectional image in the reactor water can be obtained by the one-dimensional electronic scanning, and three-dimensional information in the reactor water can be obtained by the two-dimensional electronic scanning, and the reduction in the water level and the existence of fallen parts can be monitored more understandably.

The present embodiment can obtain each effect generated in embodiment 1.

Each of embodiments 1 to 4 aforementioned can be applied to a pressurized water reactor.

### REFERENCE SIGNS LIST

2: reactor pressure vessel, 4: bottom head, 5: core, 8: core support plate, 32, 32A, 32B: ultrasonic sensor, 33: piezo-electric element, 35, 35A: sensor leading edge portion, 36: ultrasonic transmitter and receiver.

What is claimed is:

1. A method of monitoring reactor bottom area, comprising steps of:
propagating ultrasonic waves generated by a ultrasonic vibration element of a ultrasonic sensor to a sensor leading edge portion of the ultrasonic sensor which penetrates a bottom portion of a reactor pressure vessel;
propagating the ultrasonic waves propagated to the sensor leading edge portion to reactor water in the reactor pressure vessel;
receiving reflected waves of the ultrasonic waves propagated to the reactor water by the ultrasonic vibration element; and
monitoring a state of a reactor bottom area in the reactor pressure vessel by using the received reflected waves.

2. The method of monitoring reactor bottom area according to claim 1, wherein the reflected waves of the ultrasonic waves received by the ultrasonic vibration element are reflected waves from a core support member installed in the reactor pressure vessel.

3. The method of monitoring reactor bottom area according to claim 2, comprising step of monitoring either a water level of the reactor water existing below the core support member or a fallen part existing below the core support member.

4. The method of monitoring reactor bottom area according to claim 1, wherein an array-type ultrasonic sensor is used as the ultrasonic sensor.

5. The method of monitoring reactor bottom area according to claim 1, comprising steps of:
measuring multiple reflected waves of the reflected waves inside the sensor leading edge portion by using the received reflected waves;
obtaining a temperature of the sensor leading edge portion based on a sound speed transmitted in the sensor leading edge portion;
correcting the sound speed transmitting in the reactor water using the obtained temperature; and
measuring a distance up to a position where the reflected waves are generated by using the corrected sound speed.

6. The method of monitoring reactor bottom area according to claim 1, comprising steps of:
measuring multiple reflected waves of the reflected waves inside the sensor leading edge portion by using the received reflected waves, and
confirming soundness of the ultrasonic sensor using the multiple reflected waves.

7. A reactor bottom area monitoring apparatus comprising an ultrasonic sensor having a sensor leading edge portion installed on a bottom head of a reactor pressure vessel by penetrating the bottom head, a pulser receiver for transmitting and receiving ultrasonic waves, and an ultrasonic signal processing apparatus for processing the received ultrasonic signal.

8. The reactor bottom area monitoring apparatus according to claim 7, wherein the ultrasonic sensor has an ultrasonic vibration element installed at one end of the sensor leading edge portion and disposed outside the reactor pressure vessel.

9. The reactor bottom area monitoring apparatus according to claim 8, wherein a curved surface hollowed toward the one end side whereto the ultrasonic vibration element is attached is formed at another end of the sensor leading edge portion.

10. The reactor bottom area monitoring apparatus according to claim 7, wherein the sensor leading edge portion has a curved portion.

11. The reactor bottom area monitoring apparatus according to claim 7, wherein there exist a plurality of the ultrasonic sensors.

12. The reactor bottom area monitoring apparatus according to claim 8, wherein the ultrasonic sensor is an array-type ultrasonic sensor having a plurality of piezo-electric elements.

13. A nuclear reactor comprising a reactor pressure vessel, a core disposed in the reactor pressure vessel, an ultrasonic sensor having a sensor leading edge portion installed on a bottom head of the reactor pressure vessel bottom by penetrating the bottom head, a pulser receiver for transmitting and receiving ultrasonic waves, and an ultrasonic signal processing apparatus for processing a received ultrasonic signal.

14. The nuclear reactor according to claim 13, wherein the ultrasonic sensor has an ultrasonic vibration element installed at one end of the sensor leading edge portion.

15. The nuclear reactor according to claim 14, wherein a curved surface hollowed toward the one end side whereto the ultrasonic vibration element is attached at another end of the sensor leading edge portion.

16. The nuclear reactor according to claim 13, wherein the sensor leading edge portion has a curved portion and the curved portion is disposed outside the reactor pressure vessel.

17. The nuclear reactor according to claim 13, wherein there exist a plurality of the ultrasonic sensors.

18. The nuclear reactor according to claim 14, wherein the ultrasonic sensor is an array-type ultrasonic sensor having a plurality of piezo-electric elements.

19. The nuclear reactor according to claims 13, wherein a differential pressure type water level gauge is installed on the reactor pressure vessel.

20. The nuclear reactor according to claim 13, wherein installation of the sensor leading edge portion into the bottom head of the reactor pressure vessel is performed by either a welded portion becoming a pressure boundary or a flange structure.
